(19) United States
(12) Patent Application Publication
(10) Pub. No.: US 2006/0068213 A1
(43) Pub. Date: Mar. 30, 2006

(54) Decorative laminate assembly with improved tie sheet and bridging agent

(76) Inventors: Kevin O'Brien, Cincinnati, OH (US); Bryce Cole, Cincinnati, OH (US)

Correspondence Address: Douglas M. Eveleigh, Box 2828, Chicago, IL, 60690-2828, US

(21) Appl. No.: 10/954,885

(22) Filed: Sep. 29, 2004

(51) Int. Cl. B32B 27/42; B32B 29/00; B32B 23/04

(52) U.S. Cl. 428/524; 428/532; 428/913.3

(57) ABSTRACT

A decorative laminate assembly having, in descending superimposed relationship, a decorative layer, an impregnated tie sheet and a substrate. Preferably, the laminate assembly also includes an overlay layer on top of the decorative layer, and the substrate preferably contains FRP. The tie sheet is preferably impregnated with a bridging agent having a mixture of MEK, an acrylic ester, a polyester and an organic peroxide. Surprisingly, it has been discovered that impregnated tie sheet of the present invention not only bonds remarkably well to the melamine resin treated (or untreated) decorative layer, but also simultaneously bonds extremely well to an FRP substrate. The decorative laminate assemblies of the present invention can be used for a variety of purposes, including wall panels and flooring applications. When the present invention is used for flooring applications, it is preferred that the overlay layer has enhanced wear resistant qualities. The chemical mixture of the bridging agent used in the tie sheet can also be used without any sheet and can be instead deposited directly between two incompatible layers of a laminate.

### FIELD OF THE INVENTION

The present invention relates generally to decorative laminate assemblies and methods for producing the same, and more specifically, decorative laminate assemblies with an improved tie sheet and bridging agent for bonding incompatible layers of the laminate.

### BACKGROUND OF THE INVENTION

Decorative laminates have been used as a surfacing material for many years, in both commercial and residential applications, where pleasing aesthetic effects in conjunction with desired functional behavior (such as superior wear, heat and stain resistance, cleanability and cost) are preferred. Typical applications have historically included, while not limited to, furniture, kitchen countertops, table tops, store fixtures, bathroom vanity tops, cabinets, wall paneling, office partitions, and the like.

In general, decorative laminates can be classified into two broad categories, namely high pressure decorative laminates (HPDL) and low pressure decorative laminates (LPDL). As defined by the industry's governing body, the National Electrical Manufacturers Association (NEMA) in their Standards Publication LD 3-1995, high pressure decorative laminates are manufactured or “laminated” under heat and a specific pressure of more than 750 psig. Conversely, low pressure decorative laminates are typically manufactured at about 300 to 600 psig specific pressure to avoid excessive crushing of their substrate material. The other broad distinction between high pressure and low pressure decorative laminates is that the former are generally relatively thin, typically comprising a decorative surface and a phenolic resin impregnated kraft paper core, and are not self supporting as manufactured. As such they are normally bonded, with a suitable adhesive or glue, to a rigid substrate such as a particleboard or medium density fiberboard (MDF), as a separate step during final fabrication of the end product. Conversely, low pressure decorative laminates are typically comprised of a similar type of decorative surface, without the supporting core layer, which is bonded to a substrate such as particleboard or MDF in a single laminating or “pressing” operation during its manufacture.

Both high pressure and low pressure decorative laminates have historically been manufactured in heated, flat-bed hydraulic presses. With the exception of some newer types of processing equipment, high pressure laminates are typically pressed as multiple sheets in press “packs” or “books” in a multi-opening press (which is usually steam or high pressure hot water heated, and water cooled), with a 30 to 60 minute thermal cycle and 130° C. to 150° C. top temperature. On the other hand, low pressure decorative laminates are typically pressed as a single sheet or “board” in a single opening press (which is usually thermoil or electrically heated) using an isothermal, hot discharge “short cycle” of 20 to 60 seconds with press heating platen temperatures of 170° C. to 220° C. Continuous laminating or “double belt” presses for decorative laminate manufacture blur the above distinctions somewhat, in that their “cycle” times and temperatures are similar to those employed for low pressure decorative laminates. In such a process, pressures are intermediate, typically in the range of 300 to 800 psig, while the continuous laminates themselves are relatively thin, without direct bonding to a substrate material and thus requiring a second fabrication step to do so as is the case with conventional high pressure decorative laminates. The process and product dissimilarities delineated above, as well as more subtle process differences, will be appreciated by those versed in the art.

High pressure decorative laminates are generally comprised of a decorative sheet layer, which is either a solid color or a printed pattern, over which is optionally placed a translucent overlay sheet, typically employed in conjunction with a print sheet to protect the print's ink line and enhance abrasion resistance, although an overlay can be used to improve the abrasion resistance of a solid color as well. A solid color sheet typically consists of alpha cellulose paper containing various pigments, fillers and opacifiers, generally with a basis weight of 50 to 120 pounds per 3000 square foot ream. Similarly, print base papers are also pigmented and otherwise filled alpha cellulose sheets, usually lightly calendered and denser than solid color papers to improve printability, and lower in basis weight at about 40 to 75 pounds per ream, onto which surface is rotogravure or otherwise printed a design using one or more inks. Conversely, overlay papers are typically composed of highly pure alpha cellulose fibers without any pigments or fillers, although they can optionally be slightly dyed or “tinted”, and are normally lighter in basis weight than the opaque decorative papers, in the range of 10 to 40 pounds per ream.

For high wear applications (such as flooring), it is often desirable to have a more highly wear resistant top layer. Accordingly, the overlay papers may contain hard, abrasive, mineral particles such as silicon dioxide (silica), and preferably aluminum oxide (alumina), which is included in the paper's furnish during the papermaking process. Alternatively, the abrasive particles can be coated on the surface of the overlay or decorative papers, during the “treating” process described below, prior to the final lamination step. Further, the abrasive particles can be added to the resin which is used to impregnate the overlay or decorative layers, thus causing the abrasive particles to be deposited on, and to a lesser extent, dispersed within such layers. As is known in the art, if the abrasive particles are deposited on the decorative layer, a separate overlay layer may not be necessary.

Typically, these overlay and decorative print and solid color surface papers are treated, or impregnated, with a melamine-formaldehyde thermosetting resin, which is a condensation polymerization reaction product of melamine and formaldehyde, to which can be co-reacted or added a variety of modifiers, including plasticizers, flow promoters, catalysts, surfactants, release agents, or other materials to improve certain desirable properties during processing and after final press curing, as will be understood by those skilled in the art. As with melamine-formaldehyde resin preparation and additives thereto, those versed in the art will also appreciate that other polyfunctional amino and aldehydic compounds can be used to prepare the base resin, and other thermosetting polymers, such as polyesters or acrylics, may be useful as the surface resin for certain applications. It is common practice, particularly in low pressure processes, to treat the decorative paper, and optionally a high wear abrasive loaded overlay, with a coreacted melamine-urea-formaldehyde (MUF) resin, or a blend of a melamine-formaldehyde (MF) resin and urea-formaldehyde (UF) resin, where the urea serves as an inexpensive, low cost resin solids extender. However, inclusion of urea, in any form, in the surface resin should be avoided if the best moisture and water resistance of the decorative laminate assembly is to be achieved. It will be appreciated, however, that urea can be used in the practice of the present invention.

Optionally, an untreated decorative paper can be used in conjunction with a treated overlay, provided the overlay contains sufficient resin to flow into and contribute to the adjacent decorative layer during the laminating process heat and pressure consolidation so as to effect sufficient interlaminar bonding of the two, as well as bonding of the decorative layer to the core (if present) The equipment used to treat these various surface papers is commercially available and well known to those skilled in the art. The papers are normally treated to controlled, predetermined resin contents and volatile contents for optimum performance as will be well understood by those versed in the art, with typical resin contents in the ranges of 64-80%, 45-55% and 35-45% for overlay, solid color and print (unless used untreated) papers respectively, and all with volatile contents of about 5-10%. Overlay and decorative surface papers used with a low pressure process usually employ higher resin contents and catalyst concentrations (and/or stronger catalysts) to compensate for the lower pressure and resultant poorer resin flow, and the short thermal cure cycle, during the pressing operation.

The surface papers (ie., the overlay and decorative layers) of a high pressure decorative laminate are simultaneously bonded to the core during the pressing operation. The core of a conventional high pressure decorative laminate is typically comprised of a plurality of saturating grade kraft paper “filler” sheets, which have been treated or impregnated with a phenol-formaldehyde resin, which also simultaneously fuse and bond together during the laminating process, forming a consolidated, multi-lamina unified composite or laminate. Phenol-formaldehyde resins are condensation polymerization reaction products of phenol and formaldehyde. Again, those versed in the art will appreciate that a variety of modifiers such as plasticizers, extenders and flow promoters can be co-reacted with, or added to, the phenol-formaldehyde resin, that other phenolic and aldehydic compounds can be used to prepare the base resin, or that other types of thermosetting resins such as epoxies or polyesters may be used. A phenol-formaldehyde resin, however, is generally preferred in the manufacture of conventional high pressure decorative laminates, as is the use of a saturating grade kraft paper, generally with a basis weight of 70-150 pounds per ream, although other materials such as linerboard kraft paper, natural fabrics, or woven or nonwoven glass, carbon or polymeric fiber clothes or mats may also be used as the core layer, either by themselves or in combination with kraft paper. In any case, these core layers must either be treated with a resin that is chemically compatible with the “primary” filler resin (and surface resin if used adjacent to it), or if used untreated, sufficient resin must be made available from adjacent filler plies to contribute to it and insure adequate interlaminar bonding. The filler resin preparation procedures, and filler treating equipment and methodologies, are also well known to those skilled in the art. With a conventional low pressure process, typically a core layer is not used, and the decorative surface components are bonded directly to a substrate material rather than to an intermediate core layer.

During the HPDL laminating or pressing operation, the various surface and filler sheets or laminae are cured under heat and pressure, fusing and bonding them together into a consolidated, unitary laminate mass, albeit asymmetric in composition throughout its thickness. As mentioned previously, typically this process is accomplished in a multi-opening, flat bed hydraulic press between essentially inflexible, channeled platens capable of being heated and subsequently cooled while under an applied pressure.

Typically in such a press, back-to-back pairs of collated laminate assemblies (with means of separation as described below), each consisting of a plurality of filler sheets and one or more surface sheets, are stacked in superimposed relationship between rigid press plates or “cauls”, with the surfaces adjacent to the press plates. As is known in the art, such press plates are typically fashioned from a heat-treatable, martensitic stainless steel alloy such as AISI 410, and can have a variety of surface finishes which they impart directly to the laminate surface during the pressing operation, or they can be used in conjunction with a non-adhering texturing/release sheet positioned between the laminate surface components and the press plate, which will impart a selected finish to the laminate surface during pressing as well (and is later stripped off and discarded).

While martensitic stainless steel press plates are most commonly used in the manufacture of high pressure decorative laminate, optionally chrome plated to enhance their wear resistance and releasibility, austenitic stainless steels such as AISI 304, or other metal alloys such as brass, either with optional chrome plating, can also be employed, as can heat treatable wrought aluminum alloys, for example 6061 T6 temper, which surface may be anodized to increase its hardness and wear resistance. In addition, nonmetallic press plates or cauls may also be used advantageously. Such plates can be comprised of fully cured materials such as phenolic resin treated kraft paper, epoxy resin treated woven glass cloth, epoxy resin treated carbon fiber mat, or the like compositions. These plates can be optionally clad with a stainless steel or aluminum foil, which further optionally can be respectively chrome plated or anodized for improved wear resistance. Metallic press plates are typically manufactured by buffing and polishing, chemical etching, mechanical embossing, machining, shot peening, or combinations thereof, depending on the texture and surface finish desired, while the composite press plates are typically produced by a heat and pressure consolidation, i.e. lamination, and embossing process such as that described in U.S. Pat. No. 3,718,496 Willard. Release/texturing papers can be, or may have to be, used in conjunction with a particular type of press plate depending on its intrinsic self-release characteristics as well as the final laminate finish desired.

Typically, several pairs of laminate assemblies or “doublets” are interleaved between several press plates, supported by a carrier tray, to form a press pack or “book”. The laminate pairs between the press plates are usually separated from each other by means of a non-adhering material such as a wax or silicone coated paper, or biaxially oriented polypropylene (BOPP) film, which are commercially available. Alternatively, the backmost face of one or both of the laminates' opposed filler sheets in contact with each other is coated with a release material such as a wax or fatty acid salt. Each press pack, so constructed, is then inserted, by means of its carrier tray, into an opening or “daylight” between two of the heating/cooling platens of the multi-opening, high pressure flat bed press. The press platens are typically heated by direct steam, or by high pressure hot water, the latter usually in a closed-loop system, and are water cooled.

A typical press cycle, once the press is loaded with one or more packs containing the laminate assemblies and press plates, entails closing the press to develop a specific pressure of about 1000-1500 psig, heating the packs at a predetermined rate to about 130-150° C., holding at that cure temperature for a predetermined time, then cooling the packs to or near room temperature, and finally relieving the pressure before unloading the packs on their carrier trays from the press. Those skilled in the art will have a detailed understanding of the overall pressing operations, and will recognize that careful control of the laminate's cure temperature and its degree of cure are critical in achieving the desired laminate properties (as are the proper selection of the resin formulations and papers used in the process).

After the pressing operation has been completed, and the press packs discharged from the press, the press plates are removed sequentially from the press pack build-up for reuse, and the resultant laminate doublets separated into individual laminate sheets. In a separate operation, these must then be trimmed to the desired size, and the back sides sanded so as to improve adhesion during subsequent bonding to a substrate. With a continuous laminating process, the trimming and sanding operations, and sheeting if desired, are usually done in-line directly after heat and pressure consolidation and curing between the rotating double belts. Conversely, with a conventional low pressure pressing operation, usually removal of unpressed surface paper edge “flash” is the only finishing step required.

In recent years, it has become popular to combine a top layer laminate assembly with a substrate that is moisture resistant, such as PVC or fiber reinforced plastic (“FRP”). These combinations with PVC and FRP work well in applications where there will be measurable amounts of humidity. Indeed, such PVC and FRP laminates (which may be either low pressure or high pressure laminates) are much preferred to laminates using a medium density fiberboard (“MDF”) or a high density fiberboard (“HDF”), since both MDF and HDF are susceptible to moisture and hence can swell and warp in certain humidity conditions. With traditional decorative laminate assemblies, it has been common to adhere the laminated cladding to the substrate (PVC, FRP, MDF, HDF or otherwise) through the use of an adhesive. Such adhesive, however, adds to the cost and complexity of manufacture of the decorative laminate assembly, typically requiring a separate processing step. In a recent development, it has been found that a laminate using a core layer of PETG can directly bonded to a substrate, without the use of an adhesive, as shown in copending U.S. patent application Ser. No. 09/955,822. However, for certain applications, it is not desired to use PETG because of its inability to bond to certain structures. Indeed, while it has been found that PETG can directly bond to a filled PVC substrate without the use of an adhesive, it is also the case that the PETG does not bond well to an FRP panel. Moreover, because the melting temperature of PETG is 81-91° C., performing normal HDPL pressing parameters, with temperature around 135° C. and high pressure ranging from 1100 to 1400 psi, can pose problems with the PETG flowing out of the press. Lastly, because the price of PETG is somewhat high, it is desired to find a lower cost alternative, even in applications where bonding issues and low melting temperatures might not be a factor. As noted above, tie sheets and bridging agents, such as those taught by the Chou patent (U.S. Pat. No. 6,159,331) can be used to bond incompatible layers of a laminate. However, the applicants have found that existing tie sheet and bridging agent technology do not provide the bond strength that is desired in some applications, especially with FRP panels. Accordingly, there is a need for an improved tie sheet and/or bridging agent that can be used to bond incompatible layers of a laminate.

### SUMMARY OF THE INVENTION

A decorative laminate assembly having, in descending superimposed relationship, a decorative layer, an impregnated tie sheet and a substrate. Preferably, the laminate assembly also includes an overlay layer on top of the decorative layer, and the substrate preferably contains FRP. The tie sheet is preferably impregnated with a bridging agent having a mixture of MEK, an acrylic ester, a polyester and an organic peroxide. Surprisingly, it has been discovered that the impregnated tie sheet of the present invention not only bonds remarkably well to the melamine resin treated (or untreated) decorative layer, but also simultaneously bonds extremely well to an FRP substrate. As such, a single-step pressing operation can be advantageously employed, and the material, labor and equipment costs for the adhesive application to the substrate (and/or top layer), and subsequent bonding operation, can be avoided. Also, bond strength is improved as compared to existing tie sheet/bridging agent technology. The decorative laminate assemblies of the present invention can be used for a variety of purposes, including wall panels and flooring applications. When the present invention is used for flooring applications, it is preferred that the overlay layer has enhanced wear resistant qualities. The chemical mixture of the bridging agent used in the tie sheet can also be used without any sheet and can be instead deposited directly between two incompatible layers of a laminate.

### BRIEF DESCRIPTION OF THE DRAWINGS

FIG. 1 is a partial, cross-sectional, exploded, elevational view of the components of a decorative laminate according to one embodiment of the present invention present invention.

FIG. 2 is a partial, cross-sectional, elevational view of a decorative laminate assembly according to one embodiment of the present invention.

FIG. 3 is a partial, cross sectional, elevational view of a decorative laminate assembly according to one embodiment of the present invention, without a tie sheet.

### DETAILED DESCRIPTION OF THE INVENTION

While the present invention is capable of embodiment in various forms, there is shown in the following drawings, and will be hereinafter described, a presently preferred embodiment, with the understanding that the present disclosure is to be considered as an exemplification of the invention, and is not intended to limit the invention to the specific embodiment illustrated.

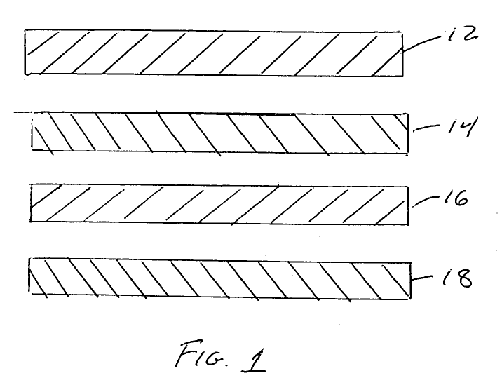

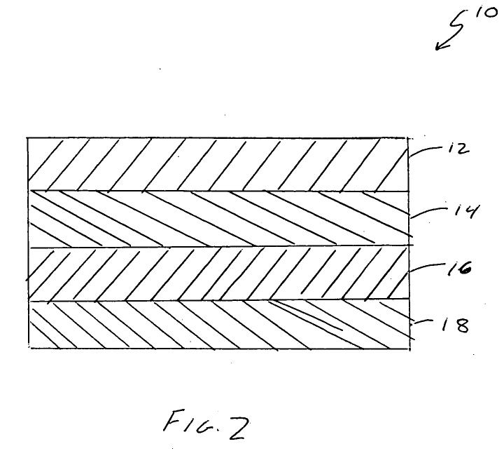

Referring to FIGS. 1 and 2, the composition of the decorative laminate 10 of a preferred embodiment of the present invention is shown, which includes, in descending superimposed relationship, a melamine formaldehyde resin impregnated overlay sheet 12, an untreated (or alternatively, melamine formaldehyde impregnated) decorative print sheet 14, a bridging agent impregnated tie sheet 16, and a substrate 18.

With regard to the overlay layer 12, although it is preferred that the overlay layer 12 is wear resistant if being used in flooring applications, it should be noted that the overlay layer may comprise a simple overlay sheet without enhanced wear resistant properties. Further, as described above, an overlay layer is not necessary at all in certain circumstances. Accordingly, the overlay layer 12 is optional in the practice of the present invention. However, in one embodiment of the present invention, an overlay layer 12 is used.

The tie sheet 16 is preferably composed of an overlay sheet treated with a bridging agent that is composed of the following chemicals:

| | |
|---|---|
| i. | methyl ethyl ketone (C₄H₈O) (“MEK”) As is known in the art, MEK has a |
| | molecular weight of 72.11, a viscosity of 0.43 cps, a viscosity conditions |
| | temperature of 20° C. and a boiling point of 79.64° C.; |
| ii. | acrylic ester, and preferably a polyester tetraacrylate available from Sartomer |
| | Company, Inc. of Exton, PA under the name CN2262. The polyester tetraacrylate |
| | contains 100% solids, has a viscosity of 500 cps, a viscosity conditions |
| | temperature of 25° C. and a specific gravity of 1.1; |
| iii. | polyester (20% solids) from Monomer - Polymer and Dajac Laboratories, Inc. of |
| | Feasterville, PA, which is referred to by this company as “polyester solution in |
| | dioxlane.” This polyester is has the following composition ranges: 70-90% 1,3 |
| | Dioxlane, 0-20% Diallylmelamine, and 0-20% Unsaturated Polyester Resin. The |
| | polyester also has 18-21% solids, a viscosity of 5.5-8.5 cps, a viscosity conditions |
| | temperature of 20° C., a boiling point of 74-75° C., and a specific gravity of 1.05-1.07; |
| | and |
| iv. | organic peroxide, and preferably tertiary-butyl peroxybenzoate, which is |
| | available from Crompton Corporation of Middlebury Connecticut under the name |
| | Esperox 10. |

In a preferred embodiment, the bridging agent contains by weight 74% MEK, 12% acrylic ester, 12% polyester and 2% organic peroxide. It should be noted, however, that these percentages for the bridging agent used in a preferred embodiment of the present invention are just examples and that the invention is not limited to specific weight percentages or precise formulas. Indeed, sufficient bonding strengths could be achieved using blends of the above chemicals in a multitude of weight percentages. Thus, it is currently believed that the weight percentage of MEK could be between 30% and 78%, the weight percentage of peroxide could be between 0.5% and 3%, the weight percentage of acrylic ester could be between 10% and 34% and the polyester could be between 10% and 35%. It should also be appreciated however, that chemical mixtures falling outside of the above ranges may also be practiced in accordance with the present invention. Moreover, the present invention is not limited to the precise chemical listed above. Indeed, other types of polyesters, peroxides (or any liquid peroxy-ester), acrylic esters or solvents can be used in the practice of the present invention. Also, while the strongest bond is believed to be achieved using a bridging agent comprising the blend of chemicals noted above, it should be appreciated that just the acrylic ester alone can be used in the practice of the present invention, although the use of at least a solvent, such as MEK, would be preferred to using the acrylic ester alone, in order to facilitate the application of the acrylic ester.

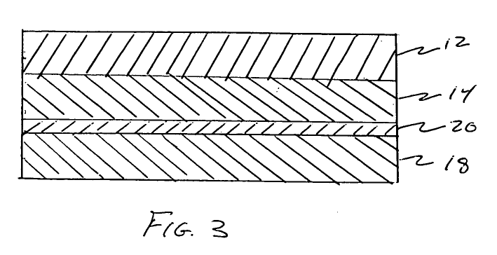

This bridging agent is treated onto the overlay sheet using a “dip and squeeze” technique at line speed of 75 to 100 feet per minute with oven settings at 40 degrees Celsius to 60 degrees Celsius, and preferably 100 feet per minute at 50 degrees Celsius, to create the treated tie sheet for this product. Preferably, the process utilizes a reverse roll or gravure roll application. However applied, it is preferred that the chemical mixture completely saturates the overlay sheet. However, it will be appreciated that any other technique for applying the chemical solution to the overlay can be used and that the present invention is not limited to a dip and squeeze, reverse or gravure roll technique. Moreover, the present invention is not limited to overlays that are completely saturated with a chemical solution. Indeed it is possible that a sufficient amount of bridging agent can achieved by just applying the chemical solution on the exterior of the overlay, without necessarily impregnating the overlay. However, as stated above, for one embodiment of the invention, it is preferred that the overlay be impregnated. Moreover, it should be noted that it is possible that the bridging agent used for the tie sheet can be utilized to bond incompatible layers of a laminate without the use of an overlay sheet or any other type of sheet or matrix, and can instead be applied directly between the two incompatible layers (ie., directly between the decorative layer and the FRP layer). FIG. 3 shows such a laminate assembly without the use of any overlay sheet, with the thin deposit of bridging agent being shown as reference numeral 20.

Preferably, the overlay sheet used in the tie sheet layer is a 14 lb/ream (22.8 gsm) wear resistant overlay created by MeadWestvaco Specialty Paper of Stamford, Conn. It should be noted that the weight of the overlay will vary depending on the application and that the overlay need not be wear resistant. Thus, for wall panels, it is preferred to use the aforementioned 22.8 gsm weight paper. However, those with skill in the art will recognize that other weights of overlay can be applied to the present invention. For instance, an overlay weight paper of 33 to 45 gsm could be used for flooring applications. It should also be noted that any type of material, cellulosic or otherwise, can be used in place of the overlay sheet, with the only prerequisite being that the material used be able to accept and hold a chemical mixture.

The substrate layer 18 is preferrably an FRP panel, which are well known in the art and which generally contain fiber reinforcement, resin matrix, fillers, and additives. As is known in the art, the fillers are added to improve areas such as cost, fire retardancy mechanical and chemical properties and the additives are to improve workability, aesthetics, and performance. FRP panels can be of varying grades, chemical components, and thickness, and are all applicable to the present invention. However, the FRP panel in a preferred embodiment is manufactured by Kemlite Inc, of Channahon Ill. with a fiberglass reinforcement in a cured polymerized styrenated/acrylated polyester matrix, along with fillers and additives such as calcium carbonate, titanium dioxide, hydrated alumina, and various pigments. The glass fibers can be arranged in chopped strands or a woven cloth and orientated in various directions in the polyester matrix. The polyester resin can be defined as a result of a condensation polymerization of dicarboxylic acids and dihydric alcohols containing either fumaric acid or a maleic anhydride. Although FRP is preferred in one embodiment of the present invention, it should be understood that any other substrate can be used in the practice of the present invention, such as PVC, MDF, HDF, cement fiberboard, etc., and that the present invention is not limited to FRP.

The layers are preferably bonded together and consolidated into a unitary decorative laminate assembly by a pressing process in a conventional multi-opening flat bed press in a single process step. However, it should be appreciated that the laminate of the present invention can also be bonded and consolidated through any type of laminating process, including, without limitation, a continuous double belt press, a single or restricted opening “short cycle” flat bed pres, or an isothermal “hot discharge” flat bed press. However, a conventional, multi-opening press is preferred for the practice of the present invention.

In a preferred embodiment, the components of the laminate assembly (i.e., the overlay layer 12, decorative layer 14, tie sheet layer 16, and the FRP substrate 18) are bonded to create a composite laminate using a press cycle with the following parameters:

| | | |
|---|---|---|
| Press close to press open: | 66.0 | minutes |
| Time to top temperature: | 8.0 | minutes |
| Time at top temperature: | 35.0 | minutes |
| Top temperature: | 144° | C. |
| Pressure: | 1400 | psi |

An assembled press pack of one embodiment of the present invention consists of the following materials in ascending order on top of a carrier tray: 6 plies of untreated kraft (cushion), desired textured plate (this could be any of the following depending on what texture/finish is desired: steel matte, steel texture, phenolic texture), 1 ply of BOPP film (which is not necessary if it is desired to take a finish from the steel plate), 1 ply of desired release paper, such as BOPP (release side up), 1 ply of melamine treated overlay, 1 ply of raw decorative print (printed side face down), 1 ply of polyester treated tie sheet; 1 panel of FRP (front side face down; front side is high gloss side), 1 ply of BOPP film, 8 plies of untreated kraft “cushion”, 1 ply of BOPP, 1 panel of FRP (front side face up; front side is high gloss side), 1 ply of polyester treated tie sheet, 1 ply of raw decorative print (printed side face up), 1 ply of melamine treated overlay, 1 ply of desired release paper (release side up), 1 ply of BOPP, desired textured plate, 6 plies of untreated kraft (cushion), as a result completing one laminate doublet. The build-up is then completed in the same sequence until a completed press pack is created, with 6 pairs of raw kraft (cushion) on the top textured plate. The completed pack consists of two laminate doublets (pairs) in between the three textured plates.

Comparative bond strength tests were performed between FRP composite laminates made in using a conventional tie sheet (referred to below as “Laminate A”) and FRP composite laminates made accordance with the present invention (“referred to below as “Laminate B”). Laminates A & B were created during the same press cycle and assembled in the press as follows, from the bottom up: 6 plies of untreated kraft (cushion), a steel matte plate, 1 ply of melamine treated overlay, 1 ply of raw decorative print (printed side face down), 1 ply of Laminate A polyester treated tie sheet; 1 panel of FRP (front side face down; front side is high gloss side), 1 ply of BOPP film, 8 plies of untreated kraft “cushion”, 1 ply of BOPP, 1 panel of FRP (front side face up; front side is high gloss side), 1 ply of Laminate B polyester treated tie sheet, 1 ply of raw decorative print (printed side face up), 1 ply of melamine treated overlay, a steel matte plate, and 6 plies of untreated kraft (cushion). This press assembly build-up results in a laminate doublet. The build-up was then completed in the same sequence until a completed press pack is created, with 6 plys of raw kraft (cushion) on the top textured plate. The completed pack thus consisted of two laminate doublets (pairs) in between the three textured plates. The press pack was then subjected to the following press cycle:

| | | |
|---|---|---|
| Press close to press open: | 66.0 | minutes |
| Time to top temperature: | 8.0 | minutes |
| Time at top temperature: | 35.0 | minutes |
| Top temperature: | 144° | C. |
| Pressure: | 1400 | psi |

For the Laminate A tie sheet, a wear resistant 22.8 gsm overlay was used and was treated with a solution of 70% MEK and 30% of the Monomer Polymer polyester solution in dioxlane at line speeds of 100 feet per minute and with an oven temperature of 50° C. For the Laminate B tie sheet, a wear resistant 22.8 gsm overlay was used and was treated with a solution of 74% MEK, 2% Esperox 10, 12% CN2262, and 12% of the Monomer Polymer polyester solution in dioxlane at line speeds of 100 feet per minute and with an oven temperature of 50° C. Thus, as can be seen, the only difference between Laminate A and Laminate B is the addition of Esperox 10 and CN2262 in the chemical mixture used to treat the tie sheet.

To test the bond strength of the decorative layer to the FRP panel for Laminates A and B, one inch by one inch samples of the laminates were bonded on the top and bottom layers via super glue to metal holding devices. These devices were then placed into an Instron Tensile tester, and subjected to a pulling (strain) force. The Instron crosshead speed was 20 mm/min with a 500 kg loading. This test was designed to measure the amount of force required to separate the decorative sheet from the FRP panel. The results revealed a surprising disparity between bonds strengths of the two different tie sheets used in the respective laminates. Below is a table with the statistical analysis regarding the bond strengths of laminate A and laminate B.

Statistical Data (for Bond Strength)

| | Laminate A | Laminate B |
|---|---|---|
| Sample Population | 43 | 34 |
| Mean (Newtons) | 1537 | 2284 |
| Mode (Newtons) | 1716 | 2696 |
| Standard Deviation | 14.45 | 9.02 |

It should be noted that the sample population for Laminate B (made in accordance with one embodiment of the present invention) was lower than that of Laminate A because in several tests, the strength of the tie sheet bond between the decorative layer and the FRP layer was greater than the superglue bond attaching the laminate to the testing machine, and thus the superglue bond failed before the bond between the decorative layer and the FRP layer created by the tie sheet. As can be seen by looking at the above data, the bond strength of Laminate B (made in accordance with the present invention) is 33% stronger than Laminate A. The standard deviation is also lower which is a result of a more uniform/consistent bond.

The foregoing description of a preferred embodiment of the invention has been presented for purposes of illustration and description, and is not intended to be exhaustive or to limit the invention to the precise form disclosed. The description was selected to best explain the principles of the invention and their practical application, to enable others skilled in the art to best utilize the invention in various embodiments and various modifications as are suited to the particular use contemplated. It is intended that the scope of the invention not be limited by the specification, but be defined by the claims set forth below.

We claim:

1. A decorative laminate assembly comprising:
a decorative layer;
a bridging agent layer below said decorative layer; and
a substrate below said bridging agent layer, wherein said bridging agent layer comprises an acrylic ester.

2. The decorative laminate assembly of claim 1, wherein said acrylic ester is polyester tetraacrylate.

3. The decorative laminate assembly of claim 1, wherein said bridging agent further comprising an organic peroxide.

4. The decorative laminate assembly of claim 3, wherein said organic peroxide is tertiary-butyl peroxybenzoate.

5. The decorative laminate assembly of claim 1, wherein said bridging agent layer further comprising a solvent.

6. The decorative laminate assembly of claim 5, wherein said solvent is methyl ethyl ketone.

7. The decorative laminate assembly of claim 1, wherein said bridging agent layer further comprises a cellulosic sheet that is impregnated with the bridging agent.

8. The decorative laminate assembly of claim 1, wherein said substrate comprises a fiber reinforced plastic.

9. The decorative laminate assembly of claim 1, further comprising an overlay layer on top of said decorative layer.

10. The decorative laminate assembly of claim 9, wherein said overlay layer is impregnated with a melamine resin.

11. The decorative laminate assembly of claim 1, wherein said decorative layer is impregnated with a melamine resin.

12. The decorative laminate assembly of claim 1, wherein said bridging agent layer further comprises a polyester.

13. The decorative laminate assembly of claim 1, wherein said bridging agent layer comprises, by weight percentage, between 30% and 78% solvent, between 0.5% and 3% peroxide, between 10% and 34% acrylic ester, and between 10% and 35% polyester.

14. The decorative laminate assembly of claim 13, wherein said bridging agent layer comprises, by weight percentage, 74% solvent, 2% peroxide, 12% acrylic ester, and 12% polyester.

15. A bridging agent for bonding incompatible layers of a laminate comprising an acrylic ester.

16. The bridging agent of claim 15, further comprising a solvent, a polyester, and a peroxide.

17. The bridging agent of claim 16, wherein the bridging agent comprises, by weight percentage, between 30% and 78% solvent, between 0.5% and 3% peroxide, between 10% and 34% acrylic ester, and between 10% and 35% polyester.

18. The bridging agent of claim 16, wherein said acrylic ester is polyester tetraacrylate, said solvent is methyl ethyl ketone and said peroxide is tertiary-butyl peroxybenzoate.

19. The bridging agent of claim 16, wherein said bridging gent comprises, by weight percentage, 74% solvent, 2% peroxide, 12% acrylic ester, and 12% polyester.
